(19) United States
(12) Patent Application Publication
(10) Pub. No.: US 2006/0177350 A1
(43) Pub. Date: Aug. 10, 2006

(54) Microchip, sampling method, sample separating method, sample analyzing method, and sample recovering method

(75) Inventors: Toru Sano, Minato-ku Tokyo (JP); Masakazu Baba, Tokyo (JP); Kazuhiro Iida, Tokyo (JP); Hisao Kawaura, Tokyo (JP); Noriyuki Iguchi, Tokyo (JP); Wataru Hattori, Tokyo (JP); Hiroko Someya, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 10/549,284

(22) PCT Filed: Mar. 19, 2004
(86) PCT No.: PCT/JP04/03751

§ 371 Date: Sep. 16, 2005

(30) Foreign Application Priority Data
Mar. 19, 2003 (JP) 2003-076401

(51) Int. Cl. G01N 1/10

(52) U.S. Cl. 422/100; 422/99

(57) ABSTRACT

A sample-carrier complex (119) is introduced into a sample introducing portion (107), and the sample-carrier complex (119) is moved and deposited on a damming portion (111). The damming portion (111) is heated at a stage in which the predetermined amount of sample-carrier complex (119) is deposited on the damming portion (111). A temperature is increased to a predetermined temperature to break down the sample-carrier complex (119) into a sample (121) and a carrier (123). A voltage is applied between the sample introducing portion (107) and a sample recovery portion (109) to cause the sample (121) to pass through a gap between columnar bodies (115) and move into a second channel (106) to perform predetermined separation and analysis or recovery operation.

### TECHNICAL FIELD

The present invention relates to a microchip and a method of extracting a sample, a method of separating a sample, a method of analyzing a sample, and a method of recovering a sample therewith.

### BACKGROUND ART

Recently research and development of microchips in which a function of separating or analyzing substances derived from living organism is included on a chip are actively performed (Patent Document 1). In these microchips, a fine separation channel is provided by using a fine processing technology, and an extremely small amount of sample can be introduced into the microchip to perform separation and analysis.

Approaches that an electrophoresis technology is introduced are proposed in a technical field in which the microchip is utilized for proteomics and genomics researches. Protein and peptide are separated by the electrophoresis and are recovered from gel to perform the analysis. In the electrophoresis in which the microchip is used, as shown in FIG. 13(a), an input channel 302 and a separation channel 304 are formed in a cross shape in a substrate 300. As shown in FIG. 13(b), the sample is inputted from a liquid reservoir 306, and the inputted sample is moved rightward by applying an electric field in a transverse direction of FIG. 13(b). As shown in FIG. 13(c), the sample in a portion where the input channel 302 and the separation channel 304 intersect each other is caused to flow into the separation channel by applying the electric field in a longitudinal direction of FIG. 13(c). Therefore, components whose speeds are different from one another can be separated.

Patent Document 1: Japanese Patent Application Laid-Open (JP-A) No.2002-131280

### DISCLOSURE OF THE INVENTION

However, the small amount of sample introduced from the input channel to separation channel can obtain only the extremely small amount of a target component during the separation. Therefore, the target component having high density cannot be obtained, and sometimes the high-accuracy analysis cannot be performed. On the other hand, when a width of the input channel is widened to increase the amount of introduced sample, a band width of the sample flowing in the separation channel is widened to decrease resolution, and sometimes the high-accuracy separation cannot be performed.

In view of the foregoing, an object of the invention is to provide a technology in which the extremely small amount of sample is efficiently separated or recovered by simple operation. Another object of the invention is to provide a technology in which the extremely small amount of sample is efficiently analyzed.

According to the invention, there is provided a microchip comprising a base material in which a channel is provided, the microchip extracting a sample from a complex of the sample and a carrier holding the sample being introduced into the channel, wherein the channel includes: an inlet through which the complex is introduced; a damming portion which stems the complex; an introduction channel which is provided from the inlet to the damming portion, the complex flowing through the introduction channel; and a sample channel which is located on a downstream side of the damming portion, the sample channel being communicated with the introduction channel through the damming portion, the sample flowing through the sample channel, the sample being extracted from the complex stemmed at the damming portion.

In the invention, the sample extraction should mean that the sample is taken out from the complex of the sample and the carrier holding the sample. The damming portion has a function of stemming the complex by preventing the complex, which flowing from the introduction channel, from moving into the sample channel.

According to the microchip of the invention, the complex flowing in the introduction channel cannot pass through the damming portion and cannot be moved to the sample channel communicated with the damming portion. Therefore, the complex introduced into the introduction channel is deposited on the damming portion and is condensed in the stem position, which increases sample concentration in the damming portion. This is because the sample is deposited in the damming portion while held in the complex.

In the case where the sample is separated, recovered, and analyzed, it is necessary that the sample is previously condensed. However, conventionally there is a limitation in the condensation. In separating the sample to obtain a band, there is room for improvement in separation efficiency. On the other hand, in the invention, the sample can be condensed in the damming portion while held by the carrier such that the complex is condensed in the damming portion. Therefore, the sample can be extracted from the complex after sufficiently condensed. Then, the sample can be moved from the damming portion to the sample channel while condensed. Accordingly, the sample can be separated, analyzed, and recovered in high concentrations in the sample channel, and these operations can efficiently be performed.

Either a physical method or a method by the remote operation may be used as the method of stemming the complex in the damming portion. When the complex is physically stemmed, for example, it is possible that the damming portion is form so as to have a communication channel by which the introduction channel and the sample channel are communicated with each other. The complex can efficiently be stemmed by forming the configuration in which the sample can pass through the communication channel while the complex cannot pass through the communication channel.

When the sample can rapidly be extracted, the structure of the complex may completely be collapsed or broken down by stimulus, or a part of the structure may be collapsed or broken down.

The microchip of the invention may comprise stimulus applying unit applying stimulus to the complex to extract the sample, the complex being stemmed by the damming portion.

Also, in the invention, the stimulus may be applied after the complex is stemmed at a predetermined position in the channel.

According to the invention, there is provided a method of extracting a sample, wherein a microchip comprising a base material in which a channel is provided is used to introduce a complex of a sample and a carrier holding the sample into the channel, and the sample is extracted from the complex by applying stimulus to the complex.

In the invention, the stimulus should mean that of magnitude of a degree in which the sample can be extracted from the complex. When the predetermined stimulus is applied to the complex deposited in the damming portion, the sample is extracted from the complex. The damming portion communicates the introduction channel and the sample channel, and the complex cannot pass through the damming portion while the sample can pass through the damming portion because the sample is smaller than the complex. Thus, in the invention, the stimulus applying unit is provided and the stimulus can be applied to the complex deposited in the damming portion to extract the sample, so that the sample extraction can securely be performed at more preferable timing.

In the microchip of the invention, the channel can include a separation portion which separates a component in the sample.

Also, according to the present invention, there is provided a method of separating a sample, wherein, after the sample is extracted from the complex by the method of extracting a sample described above, a component in the sample extracted is separated on a downstream side of the channel.

Thus, in the case where the sample contains the plural components, the separation of the components can also efficiently be performed. Because the sample can be condensed in the damming portion while held in the complex, the sample can be introduced as the condensed band into the sample channel, which allows the separation to be performed at high efficiency. The sample may contain one kind of the component, or the sample may contain not lower than two kinds of the components.

In the microchip of the invention, the channel can include an analysis portion which analyzes the sample.

Also, according to the present invention, there is provided a method of analyzing a sample, wherein after the sample is extracted from the complex by the method of extracting a sample described above, the sample extracted is analyzed on a downstream side of the channel.

According to the invention, because the sample can be moved from the damming portion to the sample channel while condensed, the samples having concentrations not less than a constant reference can be performed. Therefore, analytical accuracy and sensitivity can be improved.

In the microchip of the invention, the channel can include a recovery portion which recovers the sample.

Also, according to the present invention, there is provided a method of recovering a sample, wherein after the sample is extracted from the complex by the method of extracting a sample described above, the sample extracted is recovered on a downstream side of the channel.

According to the invention, because the sample can be moved from the damming portion to the sample channel while condensed, the sample can efficiently be recovered in high density.

In the microchip of the invention, the damming portion has plural protrusions.

In the complexes introduced into the introduction channel, the complex which first reaches the damming portion cannot pass through a gap between the protrusions and is stemmed by the damming portion. Then, a complex which subsequently reaches the damming portion is deposited in the damming portion. Therefore, the complexes can physically and securely be stayed in the damming portion by providing the plural protrusions in the damming portion. Further, the optimum configuration can be selected according to a shape and a size of the complex and the shape and the size of the sample by adjusting the shape of the protrusion and the interval therebetween to predetermined dimensions.

In the microchip of the invention, the stimulus applying unit may be a heating member.

Also, in the invention, the stimulus may be applied to the complex by heating the complex.

Thus, the sample can preferably be extracted by using the carrier whose structure is changed at a predetermined temperature to extract the sample. Further, the sample can preferably be separated or analyzed.

In the microchip of the invention, the stimulus applying unit may be a light irradiation member.

The stimulus can be applied more rapidly to the complex with the light irradiation member. Therefore, the sample extraction and the movement of the sample to the sample channel can rapidly be started by using the complex which is decomposed and cleaved by light irradiation conditions.

In the invention, the stimulus may be applied to the complex by changing pH in the channel.

Thus, the sample can be extracted by introducing a substance, such as salt and the like, for changing pH into the introduction channel to easily change the structure of the complex. Further, the sample can preferably be separated or analyzed.

Further, in the invention, the stimulus may be applied to the complex by diluting a concentration of the carrier.

Thus, for example, the sample can be extracted by a simple method. Also, the sample can preferably be separated or analyzed.

In the invention, the complex may be stemmed by keeping the complex at the predetermined position by remote operation.

In the invention, “keeping the complex by remote operation” should mean that the complex is not stemmed in the damming portion by a physical disturbance member, but predetermined operation is performed to the complex from the outside of the channel such that the complex exists selectively in the damming portion. In the case where the complex is held by the remote operation, it is not necessary that the physical disturbance member is provided in the channel. Therefore, after the stimulus is applied, that in the damming portion clogging is generated to disturb the passage of the sample by the components except for the sample, for instance, molecules constituting the carrier is suppressed in the damming portion.

For example, in the sample separation method of the invention, the remote operation may be a laser trap (hereinafter also referred to as “optical tweezers”). Thus, the damming portion is irradiated with light, and the complex can securely be held by using the optical tweezers function. In the case where the complex is held in the damming portion by the laser trap, the complexes located on the upstream side of the held complexes are disturbed by the held complexes and cannot pass through the damming portion, and the complexes are deposited in the damming portion. Therefore, the complex can securely be deposited in the damming portion without providing the physical obstacle portion.

Further, the damming portion can easily be formed at an arbitrary position in the channel after the microchip is produced. Therefore, a degree of freedom is enlarged in designing the microchip, which allows the microchip having the configuration more suitable to the purpose to be obtained. The sample can securely and rapidly be extracted from the carrier from which the sample is extracted by the stimulus and the sample movement can be started.

As described above, the invention can realize a technology in which the extremely small amount of sample is efficiently separated or recovered by simple operation. Further, the invention can realize a technology in which the extremely small amount of sample is efficiently analyzed.

### BRIEF DESCRIPTION OF THE DRAWINGS

The above objects, other objects, advantages, and features of the invention will become more apparent in the following embodiments and the accompanying drawings.

FIG. 1 is a view showing a configuration in which a general separation apparatus is applied to an embodiment;

FIG. 2 is a view showing a configuration of a microchip according to an embodiment;

FIG. 3 is a view showing a section of the microchip of FIG. 2;

FIG. 4 is a view for explaining a method of using the microchip of FIG. 2;

FIG. 5 is a view showing a configuration of a microchip according to an embodiment;

FIG. 6 is a view showing a configuration of a microchip according to an embodiment;

FIG. 7 is a view showing a configuration of a microchip according to an embodiment;

FIG. 8 is an enlarged view showing a periphery of a sample introducing portion in the microchip of FIG. 2;

FIG. 9 is a sectional view taken on line B-B′ of FIG. 8;

FIG. 10 is a process sectional view showing a method of producing a microchip according to an embodiment;

FIG. 11 is a process sectional view showing a method of producing a microchip according to an embodiment;

FIG. 12 is a process sectional view showing a method of producing a microchip according to an embodiment;

FIG. 13 is a top view showing a configuration of the conventional separation apparatus;

FIG. 14 is a view for explaining a stem method in a damming portion of the microchip of FIG. 5;

FIG. 15 is a top view showing a configuration of a damming portion of a microchip according to an embodiment;

FIG. 16 is a view showing a configuration of a channel when a separation unit and an analysis unit are provided in the microchip of FIG. 1;

FIG. 17 is a view for explaining a method of producing the damming portion in the microchip of FIG. 15;

FIG. 18 is a view for explaining a method of producing the damming portion in the microchip of FIG. 15; and

FIG. 19 is a top view showing a fluorescence microscope image of a first channel in a microchip according to example.

### BEST MODE FOR CARRYING OUT THE INVENTION

Embodiments of the invention will be described below with reference to the accompanying drawings.

### First Embodiment

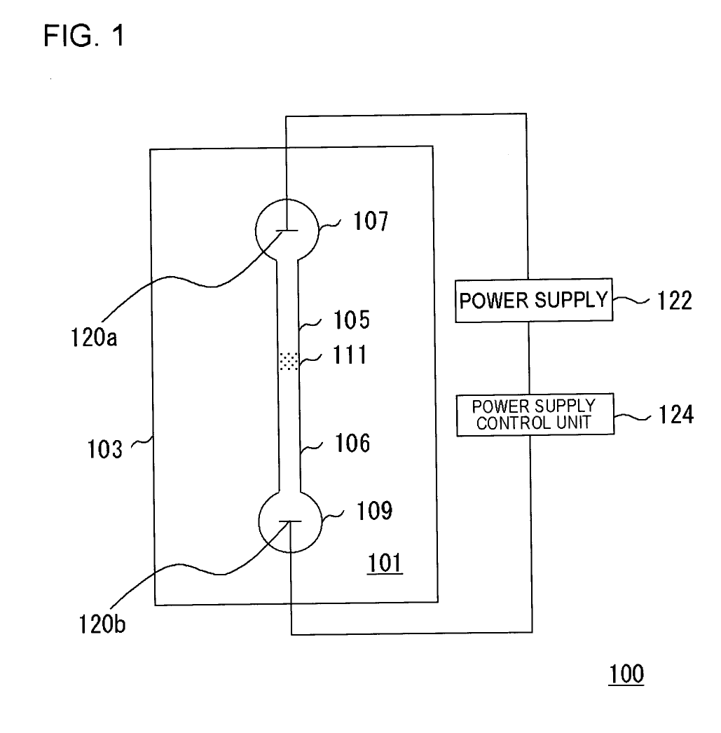

The present embodiment is about a microchip in which a physical damming member is provided in the damming portion provided in the channel. FIG. 1 is a view showing a configuration in which the microchip of the embodiment is applied to a separation apparatus. A microchip 101 constituting a separation apparatus 100 includes a sample introducing portion 107, first channel 105, a second channel 106, and a sample recovery portion 109. The sample introducing portion 107 is formed on a substrate 103. A damming portion 111 is provided in the first channel 105, and the damming portion stems the sample in a complex state in which a carrier holds the sample. A separation area (not shown) is provided at a predetermined position of the second channel 106.

The sample is introduced into the sample introducing portion 107 while held by the carrier, that is, being in the complex state, and is moved in the first channel 105. Because the sample cannot pass though the damming portion 111 while held by the carrier, it is deposited in the damming portion 111. When the sample is released from the carrier in response to the later-mentioned external stimulus applied at predetermined timing, the sample passes through the damming portion 111 and is moved through the second channel 106 provided on the downstream side of the damming portion 111 toward the downstream side, that is, toward the sample recovery portion 109 side. The separation and fractionation are performed to the sample which passes through the damming portion 111 in the second channel 106, or the sample is recovered from the sample recovery portion 109.

The separation apparatus 100 and microchip 101 are not limited to the configuration shown in FIG. 1, but any configuration can be applied thereto. In the microchip 101, an electrode 120a and an electrode 120b are provided in the sample introducing portion 107 and the sample recovery portion 109 respectively. The electrode 120a and the electrode 120b are connected to a power supply 122 outside the microchip 101. The separation apparatus 100 also includes a power supply control unit 124. The power supply control unit 124 controls voltage application patterns, such as an orientation, a potential and a time, which are applied to the electrode 120a and the electrode 120b .

Here, a silicon substrate, a glass substrate such as quartz or the substrate made of a plastic material can be used as the substrate 103. The first channel 105 or the second channel 106 can be provided by making a groove in the substrate 103. In addition, for example, the first channel 105 or the second channel 106 can also be formed such that hydrophilic treatment is performed to a hydrophobic substrate surface or hydrophobic treatment is performed to a wall portion of the first channel 105 or the second channel 106 in the surface of the hydrophilic substrate 103. In the case where the plastic material is used as the substrate 103, the first channel 105 or the second channel 106 can be formed by well-known methods suitable to the kind of the material of the substrate 103 such as etching, press molding with a metal mold such as embossing molding, injection molding, and light cured formation.

Widths of the first channel 105 and the second channel 106 are appropriately set according to the purpose of separation. For example, in the case where macromolecular component (DNA, RNA, protein, sugar chain) is extracted in a liquid fractional component (cytoplasm) of a cell, the width is set in the range of 5 μm to 1000 μn.

Not only the sample separation but sample analysis can be performed by providing an analysis area in the second channel 106 of the microchip 101. That is, the microchip 101 can also be utilized as a sample analysis apparatus. When the sample is recovered from the sample recovery portion 109, it can also be utilized as a sample recovery apparatus.

The detailed configuration of the microchip 101 will be described below. In the following embodiments, the sample introducing portion 107 or the sample recovery portion 109 can be used as a reservoir for a buffer solution and the like.

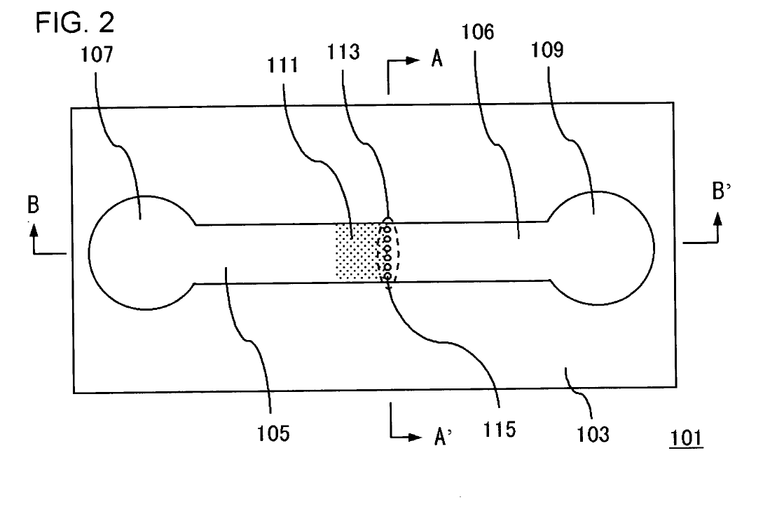

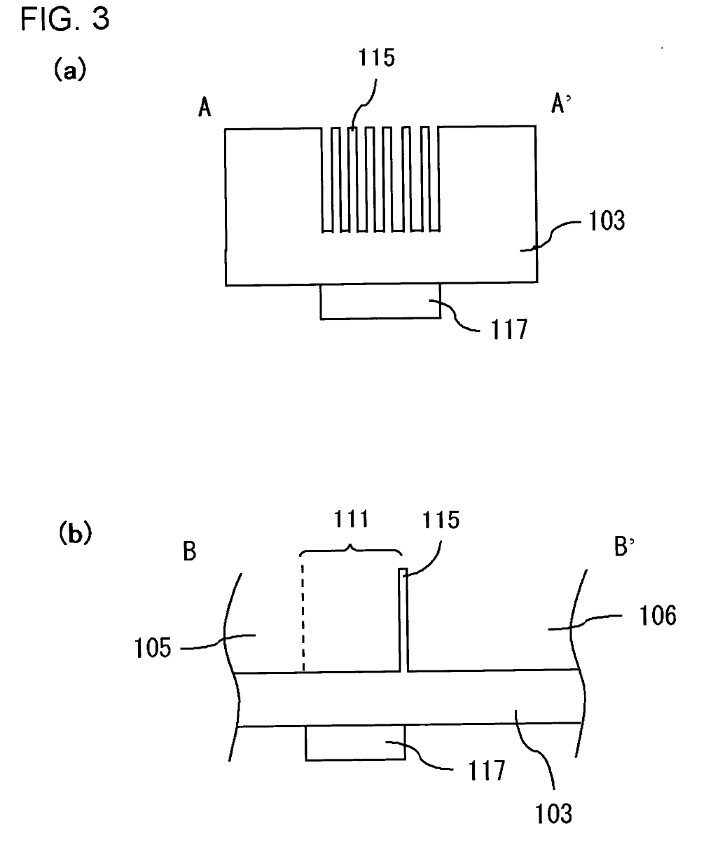

FIG. 2 is a view showing the configuration of the microchip according to the embodiment, FIG. 3(a) is a sectional view taken on line A-A′ of the microchip of FIG. 2, and FIG. 3B is a sectional view taken on line B-B′ of the microchip of FIG. 2.

In the microchip 101, a obstacle portion 113 having plural columnar bodies 115 is provided in the damming portion 111 provided in the first channel 105. As shown in FIG. 3(b), the damming portion 111 is heated from a bottom surface thereof by a heater 117. In FIG. 2, although one line of the columnar bodies 115 extends in a direction perpendicular to an extending direction of the first channel 105, the plural lines of the columnar bodies 115 may be provided in the obstacle portion 113.

A sample is introduced from the sample introducing portion 107 to the first channel 105. At this point, when the sample is held by the carrier having the size which cannot pass through a gap between the columnar bodies 115, the sample and the carrier are stemmed until the desired timing by the damming portion 111. When the temperature is increased to a predetermined temperature by the heater 117, the predetermined temperature triggers the passage of the sample through the damming portion 111, and the sample is introduced to the second channel 106 to flow down through the second channel 106 toward the downstream, namely, toward the sample recovery portion 109. Then, this process will be described in detail by taking a method of extracting the sample into the second channel 106 while the sample having an electric charge is held by the carrier broken down by heating.

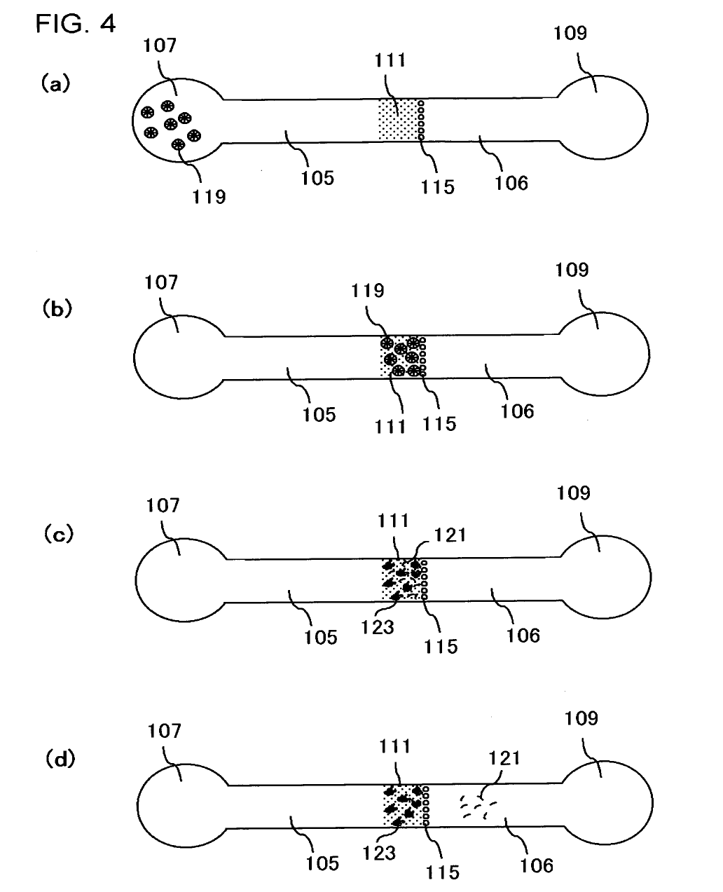

FIG. 4 is a view for explaining a method of using the microchip 101. Referring to FIG. 4, the sample extraction is performed by the following steps:
(i) the movement of a sample-carrier complex 119 by current conduction,
(ii) the deposition of the sample-carrier complex 119 on the damming portion 111,
(iii) the stop of the movement of the sample-carrier complex 119,
(iv) the release of a sample 121 by the heating,
(v) the stop of the heating, and
(vi) the movement of the sample 121 into the second channel 106. After the steps of (i) to (vi), the sample 121 may be introduced into the sample introducing portion 107 to repeat the steps from the step (i).
(i) The Movement of the Sample-Carrier Complex 119 by Current Conduction

First the sample-carrier complex 119 is introduced to the sample introducing portion 107 (FIG. 4(a)). The voltage is applied to the sample-carrier complex 119 as described in FIG. 1 between the sample introducing portion 107 and the sample recovery portion 109 such that the sample-carrier complex 119 flows from the sample introducing portion 107 toward the sample recovery portion 109 in the first channel 105.

(ii) The Deposition of the Sample-Carrier Complex 119 on the Damming Portion 111

When the sample-carrier complex 119 reaches the damming portion 111, since it cannot pass through the gap between the columnar bodies 115, it cannot pass through the damming portion 111 and is stemmed near the columnar body 115. The sample-carrier complex 119 which subsequently reaches the damming portion 111 in advance is stemmed near the stemmed sample-carrier complex 119, because the sample-carrier complex 119 which reaches the damming portion 111 is stemmed near the columnar body 115. The sample-carrier complex 119 which is moved in the first channel 105 is stemmed by the damming portion 111 and deposited (FIG. 4(b)).

(iii) The Stop of the Movement of the Sample-Carrier Complex 119

The voltage application is stopped at a state in which a predetermined amount of sample-carrier complex 119 introduced into the sample introducing portion 107 is deposited on the damming portion 111.

(iv) The Release of the Sample 121 by the Heating

When the voltage application is stopped, the heater (not shown in FIG. 4) provided in a bottom portion of the damming portion 111 is turned on to perform the heating. The sample-carrier complex 119 is decomposed into the sample 121 and a carrier 123 (FIG. 4(c)) at the time when the sample-carrier complex 119 is heated to the temperature in which a structural change occurs. At this point, the carrier 123 holding the sample 121 may be formed in a cluster of the plural molecules or may be formed in a closs-linked gigantic molecule.

(v) The Stop of the Heating

When the sample-carrier complex 119 is broken down into the sample 121 and the carrier 123, the heating by the heater is stopped.

(vi) The Movement of the Sample 121 into the Second Channel 106

The voltage is applied between the sample introducing portion 107 and the sample recovery portion 109 again such that the released sample 121 flows from the damming portion 111 toward the sample recovery portion 109. Because the released sample 121 has the size which can pass through the gap between the columnar bodies 115, it passes through the damming portion 111 and is moved though the second channel 106 (FIG. 4(d)). When the separation area or the analysis area (not shown in FIG. 4) are provided on the downstream side of the damming portion 111, the separation or the analysis can be performed for the relatively large amount of sample 121. The sample 121 may certainly be recovered from the sample recovery portion 109.

Thus, in the microchip 101, the sample-carrier complex 119 is moved through the first channel 105, and the sample 121 released from the sample-carrier complex 119 is moved through the second channel 106. Since the sample-carrier complex 119 cannot pass through the damming portion 111, it cannot be moved from the second channel 106.

Therefore, until the predetermined amount of sample-carrier complex 119 is deposited, the sample 121 cannot be moved to the second channel 106 and deposited as the sample-carrier complex 119 in the damming portion 111. The process of releasing the sample 121 from the sample-carrier complex 119 can easily be performed by temperature control with the heater 117. Accordingly, when the separation operation is performed in the second channel 106, the separation, namely, the movement of the sample 121 can be started while the larger amount of sample 121 is condensed, which allows the separation to be performed with high accuracy. Further, when the analysis operation is performed, measurement accuracy and sensitivity can be improved.

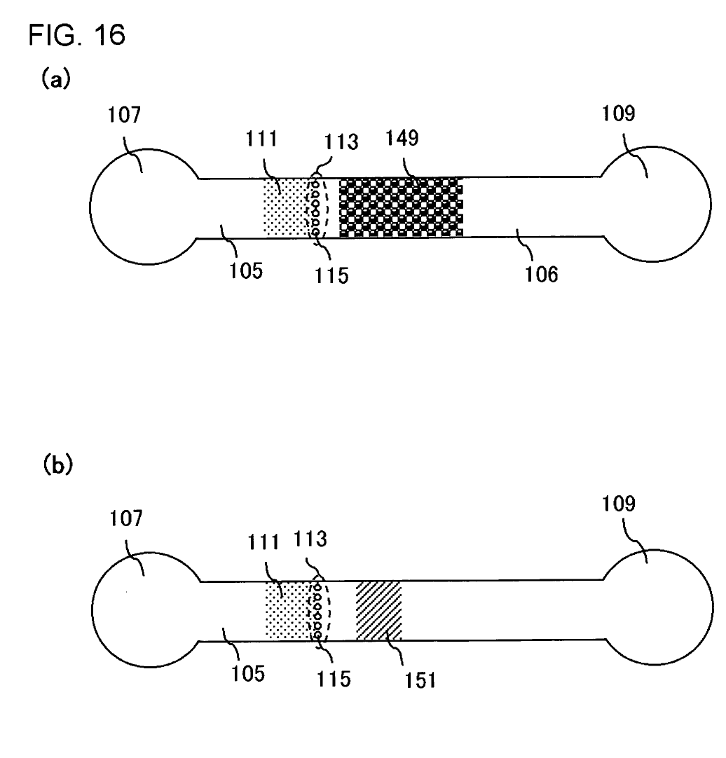

FIG. 16 is a view showing the configuration of the channel when a sample separation portion 149 or a sample analysis portion 151 is provided in the microchip 101. Referring to FIG. 16(a), the sample separation portion 149 is provided on the downstream of the damming portion 111. Columnar bodies having diameters smaller than that of the columnar body 115 are formed in the sample separation portion 149. Thus, the sample 121 in the sample-carrier complex 119 deposited in the damming portion 111 is separated from the sample-carrier complex 119 at the time when the sample-carrier complex 119 rises to a predetermined temperature, the sample passes through the damming portion 111, and is separated by the sample separation portion 149.

At this point, the sample 121 is condensed in the damming portion 111, so that the sample concentration can be increased at the start of the separation. Since the predetermined amount of sample-carrier complex 119 is stored in the damming portion 111, the sample separation can be performed while the sufficient amount of sample is ensured. Thus, in the microchip 101, the component in the sample 121 can be separated after the relatively large amount of sample is condensed in the damming portion 111. At this point, the concentration of each fraction separated by the sample separation portion 149 can also be increased. Accordingly, the separation can also securely and efficiently be performed for the small amount of sample.

FIG. 16(b) shows an example in which the sample analysis portion 151 is formed in the second channel 106. The sample in the sample-carrier complex 119 is deposited and condensed in the damming portion 111, so that the analysis can also efficiently be performed. The analytical type is not particularly limited in the sample analysis portion 151. For example, the sample analysis portion 151 is irradiated with the light having a predetermined wavelength from above the microchip 101 and the detection is operated from the bottom surface of the microchip 101, which allows the substance having a specific absorption wavelength to be detected or determined.

There is no particular limitation to the sample-carrier complex 119 so long as it can secure hold the sample 121 to carry to the damming portion 111. For example, liposome, dendrimer, fine particles, and the like in which the sample 121 is held can be used. The carrier may be selected from the materials used for DDS (Drag Delivery System). The size of the sample-carrier complex 119 is not particularly limited as long as it cannot pass through the gap between the columnar bodies 115.

Further, the gap between the columnar bodies 115 is not particularly limited as long as it causes the sample 121 to pass through and the sample-carrier complex 119 not to pass through. Although the microchip 101 has the configuration in which the columnar bodies 115 are provided in the obstacle portion 113, the obstacle member constituting the obstacle portion 113 is not limited to the columnar bodies 115. For example, the obstacle member formed in a slit shape may be provided. The obstacle member may be formed by a porous material which only the particles having diameters not larger than a predetermined size permeate.

Then, the method of preparing the microchip 101 shown in FIG. 3 and sample-carrier complex 119 will be described. In this case, it is exemplified that the sample 121 is DNA, the carrier 123 is a block copolymer, and the sample-carrier complex 119 is a micell formed by the block copolymer and the sample, namely, DNA involved therein.

At first, the preparation of the microchip 101 is performed as follows: The first channel 105, the second channel 106, sample introducing portion 107, the sample recovery portion 109 may be formed in the substrate 103 in the same way described in FIG. 1.

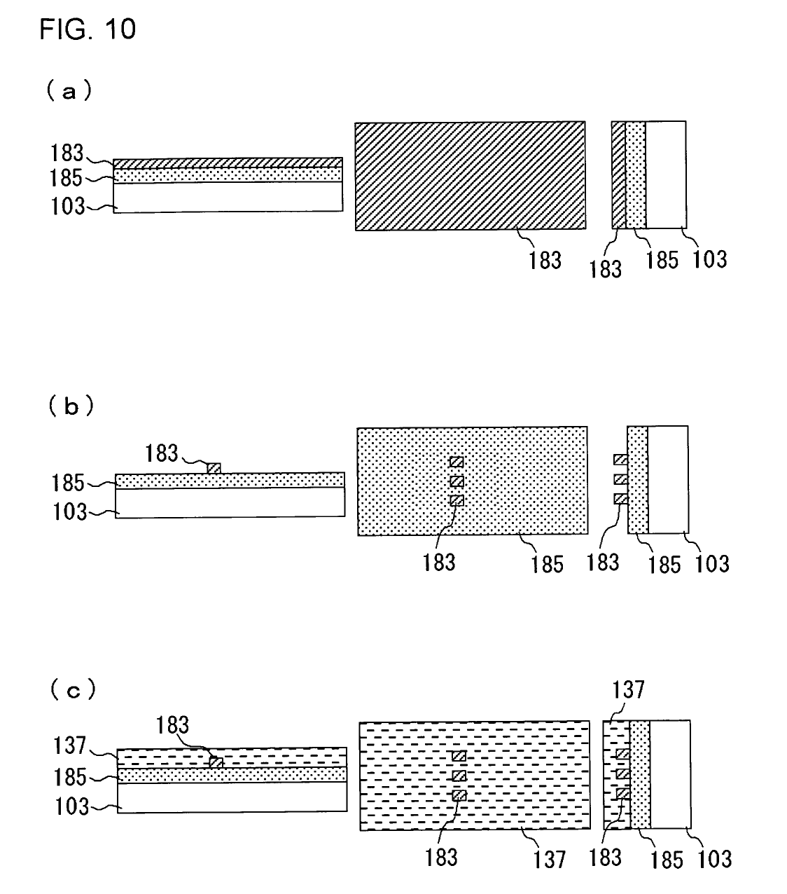

For example, the columnar bodies 115 can be formed on the substrate 103 by etching the substrate 103 in a predetermined pattern shape. The forming method thereof is not particularly limited. FIGS. 10, 11 and 12 are a process sectional view showing an example of the method. In each drawing, the center is a top view, and the right and the left are sectional views. In the method, the columnar bodies 115 provided in the damming portion 111 of the first channel 105 are formed by utilizing an electron beam lithography technology with calix-arene for fine process resist. An example of a molecular structure of calix-arene is shown below. Calix-arene is used as an electron beam exposure resist, and calix-arene can preferably be utilized as a nano-processing resist.

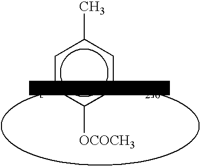

In this case, a silicon substrate having a plane direction of (100) is used as the substrate 103. As shown in FIG. 10(a), a silicon oxide film 185 and a calix-arene electron beam negative resist 183 are sequentially formed on the substrate 103. The file thicknesses of the silicon oxide film 185 and the calix-arene electron beam negative resist 183 are set at 40 nm and 55 nm respectively. Then, an area which becomes the columnar bodies 115 is exposed by the electron beam (EB). Development is performed by xylene, and rinsing is performed by isopropyl alcohol. As shown in FIG. 10(b), the calix-arene electron beam negative resist 183 is patterned through this process.

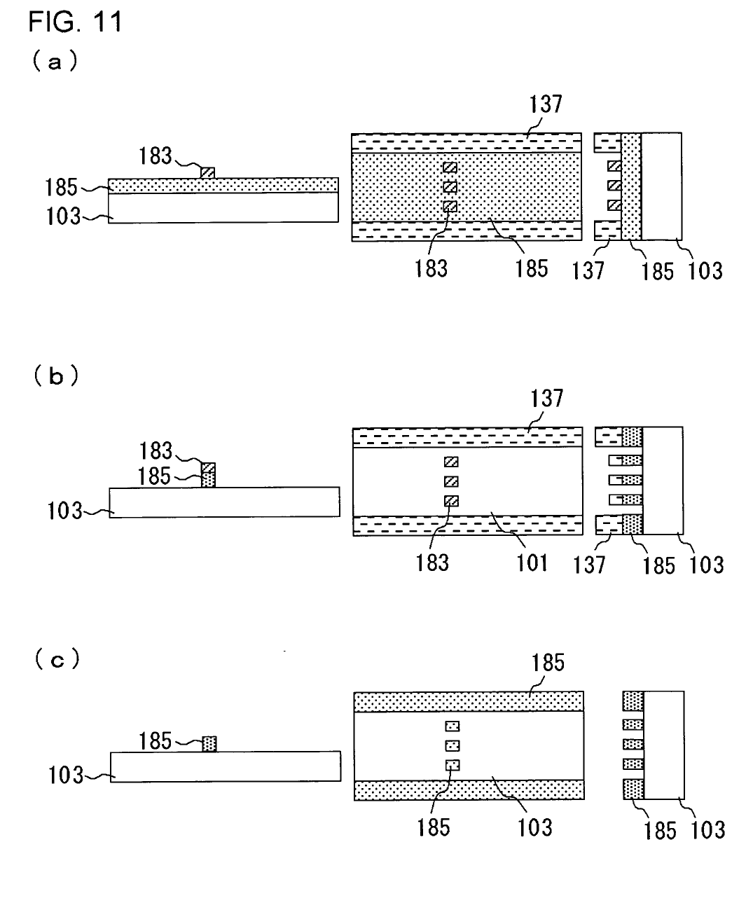

Then, a positive photoresist 137 is coated over the surface (FIG. 10(c)). The film thickness is set at 1.8 μm. Then, mask exposure is performed such that the areas which becomes the first channel 105 and second channel 106 are exposed, and the development is performed (FIG. 11(a)).

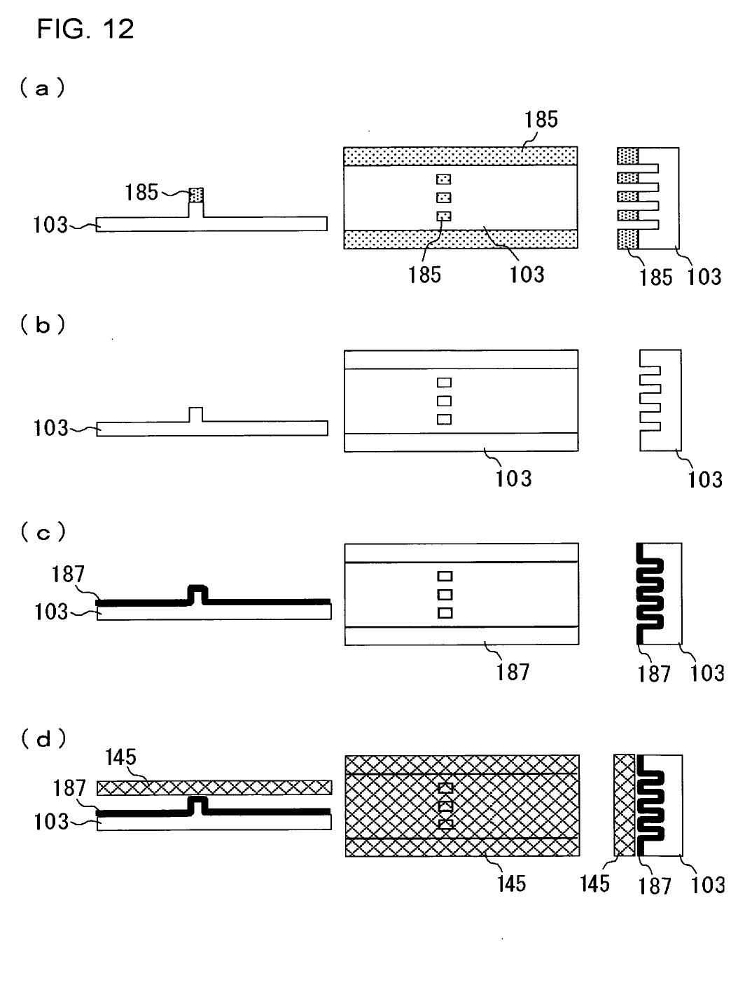

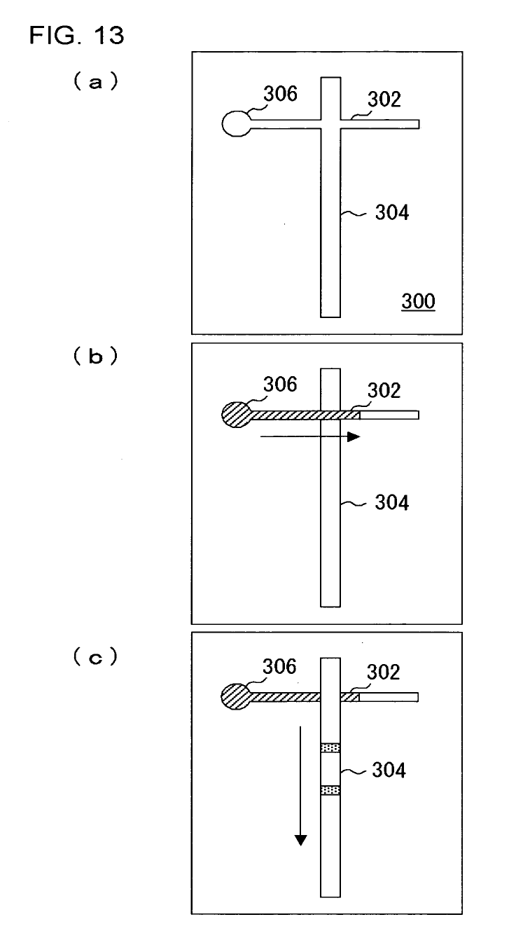

Then, RIE etching of the silicon oxide film 185 is performed by using mixture gas of CF_{4 and CHF}₃. The post-etching film thickness is set at 40 nm (FIG. 11(b)). After the resist is removed i by organic cleaning with mixture solution of acetone, alcohol, and water, oxidation plasma treatment is performed (FIG. 11(c)). Then, ECR etching of the substrate 103 is performed with HBr gas. A post-etching step of the silicon substrate 103, namely, a height of the columnar body 115 is set at 400 nm (FIG. 12(a)). The silicon oxide film 185 is removed by performing wet etching with BHF buffered hydrofluoric acid (FIG. 12(b)). Thus, the first channel 105, the columnar body 115, and the second channel 106 are formed on the substrate 103.

At this point, it is preferable that hydrophilic treatment is performed to the surface of the substrate 103 subsequent to the process of FIG. 12(b). A dispersion solution of the sample-carrier complex 119 is smoothly introduced into the first channel 105, the second channel 106, and the gap between the columnar bodies 115 in the damming portion 111 by performing the hydrophilic treatment to the surface of the substrate 103. Particularly, in the damming portion 111 in which the first channel 105 is finely formed 115 by the columnar bodies 115, capillary phenomenon preferably promotes the introduction of a movement phase by performing the hydrophilic treatment to the surface of the first channel 105. Further, it is preferable to suppress that the sample-carrier complex 119 is nonspecifically absorbed to the surface the first channel 105 to change the structure and a hydrophobic portion is exposed to release the sample 121.

Therefore, after the process of FIG. 12(b), the substrate 103 is put in a furnace to form a silicon thermal oxide film 187 (FIG. 12(c)). In this case, heat treatment conditions are selected such that the thickness of the oxide film becomes 30 nm. Difficulty in introducing the liquid into the separation apparatus can be eliminated by forming the silicon thermal oxide film 187. Then, electrostatic bonding is performed by a cover 145, and sealing is performed to complete the microchip 101 (FIG. 12(d)).

In the case where silicon is used as the substrate 103, the patterning can also be performed by Sumiresist NEB (product of Sumitomo Chemical Co., Ltd) and the like instead of the calix-arene electron beam negative resist 183. The damming portion 111 can be designed according to the size of the sample-carrier complex 119 by appropriately selecting the kind of the resist.

In the case where the plastic material is used as the substrate 103, the columnar bodies 115 can be formed by the well-known methods suitable to the kind of the material of the substrate 103 such as etching, press molding with a metal mold such as embossing molding, injection molding, and light cured formation.

In the case where the substrate 103 is made of the plastic material, a master is produced by machining or etching, a metal mold is produced from the master by electroforming of reversely transferring, and the substrate 103 in which the columnar bodies 115 are formed can be formed with the metal mold by injection molding or injection pressure molding. The columnar bodies 115 can also be formed by pressing with a die. Further, the substrate 103 in which the columnar bodies 115 are formed can be formed by rapid prototyping with a light-cured resin.

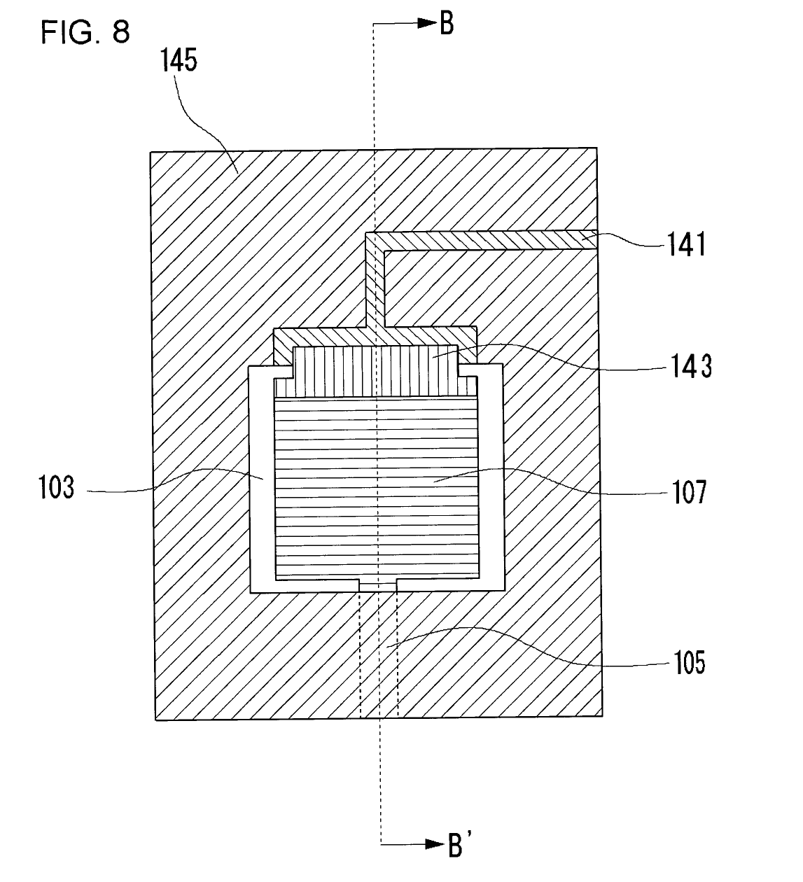

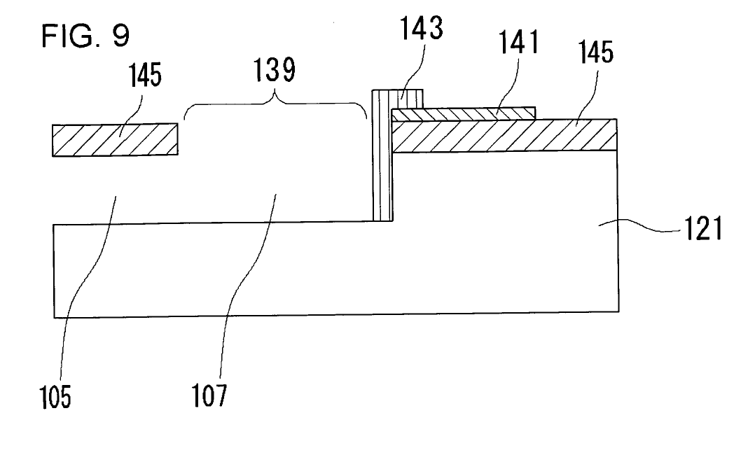

Then, the method of forming the electrode in the sample introducing portion 107 and the sample recovery portion 109 will be described. In this case, the sample introducing portion 107 will be described as an example with reference to FIGS. 8 and 9. FIG. 8 is an enlarged view showing a periphery of the sample introducing portion 107 in the microchip 101 of FIG. 2, and FIG. 9 is a sectional view taken on line B-B′ of FIG. 8. The cover 145 is arranged on the substrate 103 in which the first channel 105 and sample introducing portion 107 are provided. An opening 139 is made in the cover 145 such that the buffer solution and the like can be injected. A conductive path 141 is provided on the cover 145 so as to be connected to the external power supply.

Further, as shown in FIG. 9, an electrode plate 143 is provided along a wall surface of the sample introducing portion 107 and the conductive path 141. The electrode plate 143 and the conductive path 141 are crimped each other and electrically connected. The sample recovery portion 109 has the same structure as described above. In the electrode plates 143 formed in the sample introducing portion 107 and the sample recovery portion 109 respectively, when a lower surface of the substrate 103 is connected to the external power supply (not shown in the drawing) by ensuring electrical conduction in the lower surface, the voltage can be applied.

Returning to FIG. 3, after the substrate is processed in the above manner, a heater 117 is provided in the bottom portion of the substrate 103 as shown in FIG. 3(b). The heater 117 controls the temperature of the damming portion 111.

In the case where the plastic is used as the material of the substrate 103, it is also preferable that the hydrophilic treatment is performed to the surface.

With reference to the surface treatment for imparting the hydrophilic property, for example, a coupling agent having a hydrophilic group can be applied to the sidewall of the first channel 105 or the second channel 106. For example, a silane coupling agent having an amino group can be cited as the coupling agent having the hydrophilic group. Specifically examples include N-β(aminoethyl)γ-aminopropylmethyldimethoxysilane, N-β(aminoethyl)γ-aminopropylmethyltrimethoxysilane, N-β(aminoethyl)γ-aminopropyltriethoxysilane, γ-aminopropyltrimethoxysilane, γ-aminopropyltriethoxysilane, and N-phenyl-γ-aminopropyltrimethoxysilane. These coupling agents can be applied by a spin coating method, a spray method, a dipping method, a gas phase growth method, and the like.

Then, the sample-carrier complex 119 will be described. Nucleic acid is used as the sample 121. For example, DNA is selected as the nucleic acid. Because DNA is polyanion, when the molecule including polycation is used as the carrier 123, the micell can be formed while involving DNA. This micell can be used as the sample-carrier complex 119.

A block copolymer of the polycation and a stimuli-sensitive polymer can be used as the molecule including the polycation. In the embodiment, because the sample-carrier complex 119 is cleaved by the heating with the heater 117, a temperature-responsive polymer is used as the stimuli-sensitive polymer.

For example, the polymer having the amino group can be used as the polycation. Specifically poly-L-lysine (polyLys) and the like can be utilized. The polymer having LCST (Lower Critical Solution Temperature) can be used as the temperature-responsive polymer. The polymer having LCST includes a polyacrylamide derivative having an alkyl substituent such as poly N-isopropyl acrylamide (PIPAAm). The structure having the given LCST can be selected according to a heat-resistant property and the like of the sample 121.

For example, these block copolymers can be prepared according to JP-A No. H9-169850 or the method described in A. Harada and K. Kataoka, Macromolecules, 28, p. 5294-5299 (1995).

The obtained polycation-temperature-responsive polymer block copolymer, for example, polyLys-PIPAAm block copolymer is dissolved in a predetermined solvent such that the concentration is not lower than CMC (Critical Micell Concentration). The solution of the sample 121 is mixed therewith to form the micell. For example, a dialysis method and a method using ultrasonic waves can be adopted as the method of forming the micell.

The micell obtained in the above manner involves DNA which is of the sample 121. In the micell, the temperature-responsive polymer is orientated toward a water phase side. The micell is used as the sample-carrier complex 119 and caused to reside in the damming portion 111 as described above. When the damming portion 111 is heated at predetermined timing, a temperature-responsive area of the block copolymer shrinks rapidly at LCST of the temperature-responsive polymer and at least a part of the micell collapses. Therefore, DNA can selectively be moved to the second channel 106, provided on the downstream of the damming portion 111, by applying the electric field such that the sample recovery portion 109 becomes an anode.

When the copolymers constituting the carrier 123 are aggregated in elevating the temperature, the passage of the carrier 123 through the damming portion 111 can further be suppressed, which allows only the sample 121 to be selectively moved to the second channel 106. In this case, after separation or analysis of the sample 121 is ended, the temperature is decreased to temperatures not higher than LCST, which allow the dissolution thereof in water again. At this point, because DNA does not exist in the damming portion 111, the dissolved copolymer passes through the gap between the columnar bodies 115 without forming the micell. Therefore, the carrier 123 can be recovered from the sample recovery portion 109 to reuse.

In addition to the polycation and the temperature-responsive polymer, a hydrophilic polymer-temperature-responsive polymer-polycation block copolymer in which a hydrophilic polymer is used may be used as the carrier 123 in order to more stably form the micell involving DNA. When the molecule having the hydrophilic polymer is used as the carrier 123, preferably the area of the polycation and DNA which is of the polyanion can be arranged in an inner phase and the hydrophilic polymer can be arranged in a water phase.

For example, polyethylene derivatives such as polyethylene glycol (PEG), polyethylene oxide (PEO), and polyvinyl alcohol (PVA); and polysaccharides such as pullulan and dextran can be used as the hydrophilic polymer. Specifically PEG-PIPAAm-polyLys block copolymer can be cited as an example of the hydrophilic polymer-temperature-responsive polymer-polycation block.

The case in which the sample 121 has the anionic property is illustrated in the above description. On the other hand, in the case where the sample 121 is polycation, the micell can similarly be obtained by providing the anionic area such as polycarboxylic acid and polyphosphoric acid in the carrier 123. In the case where the sample 121 has a hydrophobic property, a hydrophobic area such as polystyrene can be formed in the carrier 123.

The microchip according to the embodiment can be applied to the separation and analysis for various components including the tissue-derived component such as the high-molecular weight components (DNA, RNA, protein, sugar chain, and the like) and the low-molecular weight components (steroid, glucose, peptide, and the like) in the liquid fractionation obtained by the breakage of the cell.

The embodiment is not limited to these processes, and any sample including the components having different migration distances can be used as the separation target by utilizing the external force. For example, the method in which the electric field is applied to move the sample by electrophoresis or electro-osmotic flow, and the method in which pressure is applied with a pump to move the sample can be used as the external force.

### Second Embodiment

This embodiment is a mode, in which the micell having a disulfide bond is used and a reducing agent introduced into the first channel 105 triggers the collapse of the sample-carrier complex 119 in the microchip 101 (FIG. 2) described in the first embodiment. The configuration of the microchip according to the embodiment is basically similar to the microchip 101. However, it is not necessary to heat the damming portion 111, so that the heater 117 is not particularly provided.

When the sample 121 is the polyanion such as DNA, for example, polythiol-polycation-hydrophilic polymer block copolymer can be prepared and used to form the micell involving the sample 121. Since the carrier 123 has the polycationic area, the carrier 123 and the sample which is of the polyanion can form the poly-ion-complex micell. In this case, polythiol should mean the polymer having a monomer unit whose side chain has a —SH group.

A PEG-polyLys-thiol group introduced polyLys block copolymer is used as such the block copolymers, the sample 121 which is of the polyanion is mixed therewith under the existence of the reducing agent, and then the reducing agent is removed by the dialysis to form the micell. For example, PEG-polyLys-thiol group introduced polyLys can be prepared according to the method described in JP-A No. 2001-146556.

After the micell is caused to reside in the damming portion 111, when a reducing reagent such as DTT (dithiothreitol) is introduced from the sample introducing portion 107, the micell collapses to release the sample 121 because the disulfide bond formed between the carriers 123 constituting the micell is cleaved. Therefore, the sample 121 can be released at predetermined timing to pass through the damming portion 111 without heating the damming portion 111.

### Third Embodiment

This embodiment differs from the first embodiment in the configuration of the damming portion 111 of the microchip.

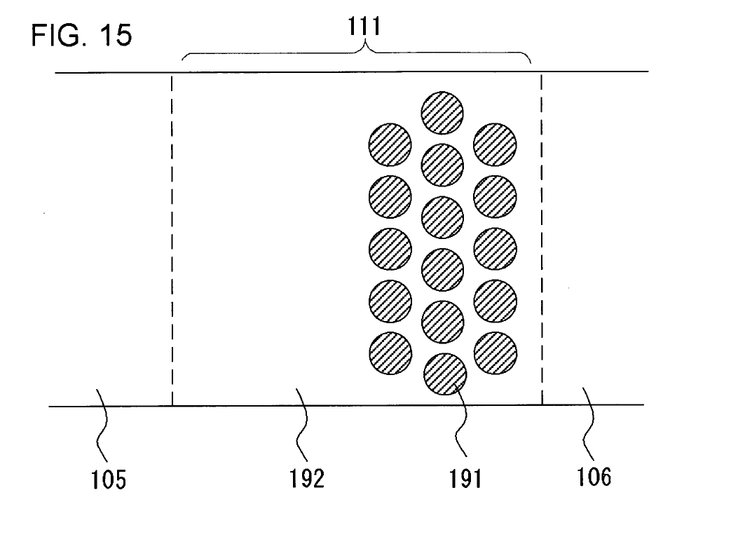

FIG. 15 is a top view showing the damming portion 111 of a microchip according to the embodiment. Referring to FIG. 15, plural hydrophobic areas 191 are regularly arranged at substantially even intervals in the damming portion 111. The surface of the substrate (not shown) made of quartz or the like is exposed and is formed in the hydrophilic area 192 in the area except for the hydrophobic areas 191. The hydrophobic property of the damming portion 111 is properly controlled by forming the hydrophobic/hydrophilic patterns. A dispersing medium of the sample-carrier complex 119 exists selectively in the upper portion of the hydrophilic area 192, and the upper portion of the hydrophobic area 191 becomes empty.

As a result, similarly to the columnar bodies 115 in the first embodiment, the hydrophobic area 191 can stem the sample-carrier complex 119 which reaches the damming portion 111 from the first channel 105. The sample-carrier complex 119 cannot pass through the damming portion 111 and is deposited in the damming portion 111. When the sample-carrier complex 119 is decomposed by applying the predetermined stimulus such as the heating, since the sample 121 has the molecular size smaller than that of the sample-carrier complex 119, it can pass through the hydrophilic area 192 of the damming portion 111.

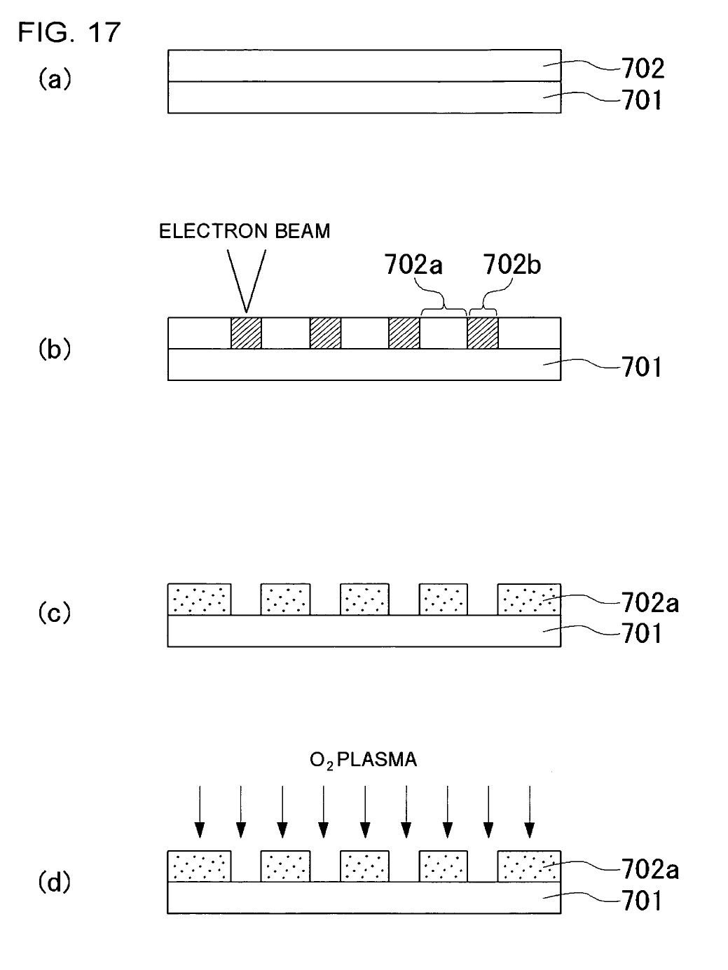

The method of producing the damming portion 111 of FIG. 15 is performed by forming, for examle, the hydrophobic area on the hydrophilic substrate. FIG. 17 is a view for explaining the method of producing the damming portion of FIG. 15. First, as shown in FIG. 17(a), an electron beam exposure resist 702 is formed on a substrate 701. Then, the electron beam exposure resist 702 is exposed in a pattern having a predetermined shape by the electron beam (FIG. 17(b)), which forms an unexposed area 702a and an exposed area 702b. When the exposed area 702b is dissolved and removed, an opening patterned in the predetermined shape is formed as shown in FIG. 17(c). Then, as shown in FIG. 17(d), oxygen plasma ashing is performed. The oxygen plasma ashing is required in forming the sub-micron order pattern. When the oxygen plasma ashing is performed, a ground to which the coupling agent adheres is activated to obtain the surface suitable for the precise pattern formation. On the contrary, when the large patterns not lower than micrometer order are formed, the need thereof is not high.

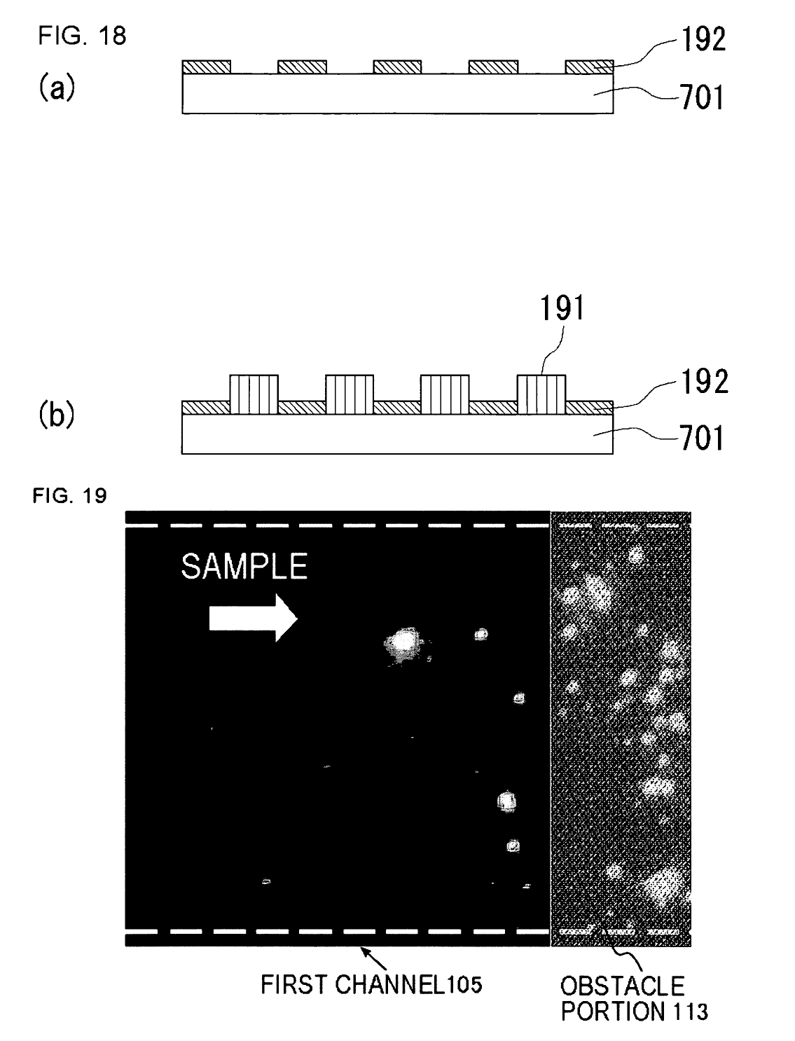

The state of FIG. 18(a) is obtained after the ashing. In the figure, resist residues and contaminations are deposited to form a hydrophilic area 192. In the state of things, the hydrophobic area 191 is formed (FIG. 18(b)). For example, the gas phase growth method can be used as the method of depositing the film constituting the hydrophobic area 191. In this case, the substrate and a solution containing the coupling agent having a hydrophobic group are arranged in a sealed chamber and left to stand for a predetermined time, which allows the film to be formed. According to this method, since the solvent and the like do not adhere to the surface of the substrate, the treatment film having the desired fine pattern can be obtained.

Another film deposition method can be the spin coating method. In the spin coating method, the solution of the coupling agent having the hydrophobic group is applied to perform the surface treatment, and the hydrophobic area 191 is formed. 3-thiol propyl triethoxysilane can be used as the coupling agent having the hydrophobic group. The dipping method and the like can also be used as the film deposition method. The hydrophobic area 191 is not deposited on the upper portion of the hydrophilic area 192, but deposited only on the exposed portion of the substrate 701, which obtains the surface structure in which the many hydrophobic areas 191 are formed while separated from one another as shown in FIG. 15. The hydrophobic treatment of the substrate is realized by causing a compound to adhere to the substrate surface or by bonding the compound to the substrate surface, the compound including within a molecule the structure both a unit adsorbed or chemically bonded to the substrate material and a unit having a hydrophobic decorative group. For example, silane coupling agent can be used as the compound.

Also, the hydrophobic treatment can be performed by a printing technology such as stamping and inkjet printing. A PDMS resin is used in the stamping method. In the PDMS resin, resinification is performed by polymerizing silicone oil, and the gap between the molecules is filled with the silicone oil even after the resinification. Therefore, when the PDMS resin is brought into contact with the hydrophilic surface, for example, the glass surface, the contact portion becomes the strong hydrophobic property to repel water. The concave is formed at the position -corresponding to the channel portion in a PDMS block by utilizing this phenomenon, and the PDMS block is brought into contact with the hydrophilic substrate as a stamp, which allows the channel to be easily produced by the above hydrophobic treatment.

In the inkjet printing method, low-viscous type silicone oil is used as ink of the inkjet printing. The same effect is also obtained by printing the pattern such that silicone oil adheres to the channel wall portion.

### Fourth Embodiment

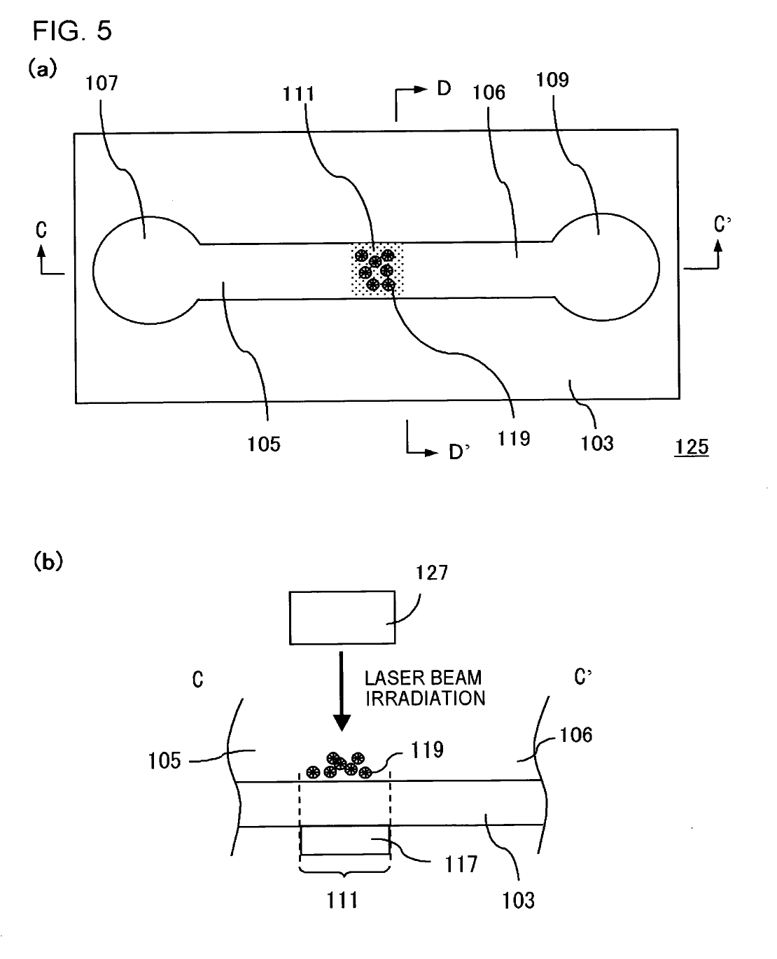

This embodiment is a microchip having a configuration which differs from that of the first embodiment in the method of stemming the sample in the damming portion 111. FIG. 5 is a view showing the configuration of the microchip according to the embodiment. FIG. 5(a) is a top view of a microchip 125 and FIG. 5(b) is a sectional view taken on line C-C′ of the microchip 125 in FIG. 5(a).

As shown in FIGS. 5(a) and 5(b), in the microchip 125, no physical disturbance member is provided in the damming portion 111. As shown in FIG. 5(b), a light source 127 which irradiate the damming portion 111 with the laser beam is provided above the damming portion 111. The sample-carrier complex 119 can be deposited in the damming portion 111 by a laser trap.

The laser trap is an apparatus in which the cell and the particle are trapped by utilizing light radiation pressure generated in irradiating the substance with two laser beams as if the substance is grasped with the tweezers. When the cell and the particle are irradiated with the laser beam by focusing the laser beam, the laser beam is refracted due to the difference in medium, and momentum of the light is changed. At this point, force in the opposite direction to the momentum is generated in the particle, which allows the particle to be trapped at a focal point. In the laser trapping, the trapping of the particle having orders not lower than nanometer can be performed with no contact. Therefore, when it is applied to the microchip of the embodiment, the sample-carrier complex 119 can be held in the damming portion 111 by remote operation without providing the physical obstacle portion 113 in the damming portion 111.

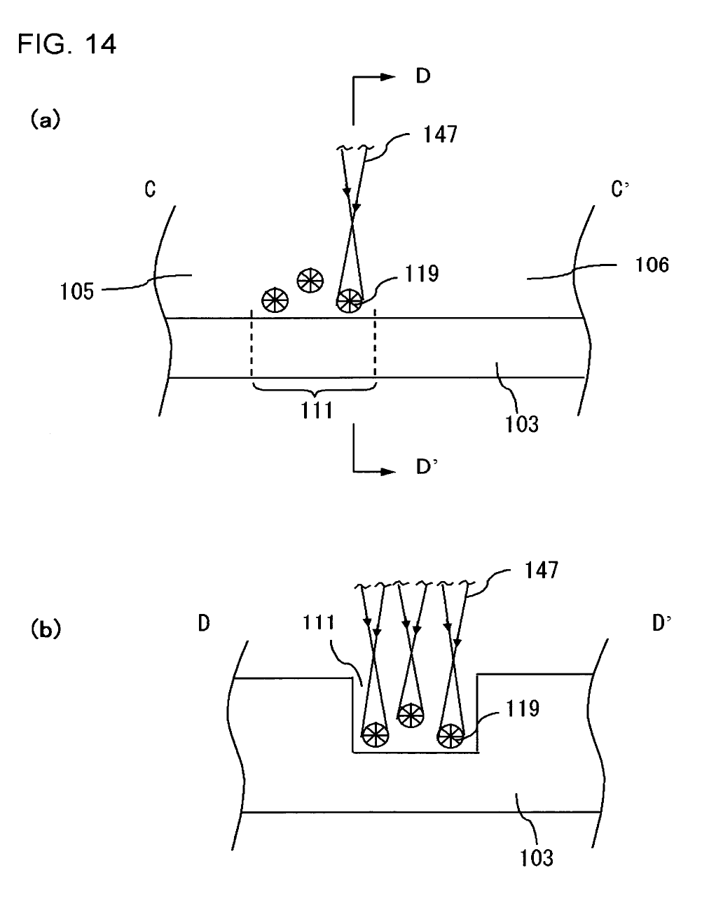

This state will be described with reference to FIG. 14. FIG. 14 is a view for explaining the method of damming the sample in the damming portion 111 of the microchip of FIG. 5. FIG. 14(a) is a sectional view taken on line C-C′ of the microchip of FIG. 5, and FIG. 14(b) is a sectional view taken on line D-D′ of FIG. 5 and FIG. 14(a). As shown in FIGS. 14(a) and 14(b), in the damming portion 111, the sample-carrier complex 119 located on the downstream side is held in the damming portion 111 by a optical tweezers 147, and the sample-carrier complex 119 located on the upstream side is stemmed by the sample-carrier complex 119 trapped by the optical tweezers 147.

The optical tweezers 147 grasps the micro substance in water in noncontact and noninvasive manners by laser beam focused with a lens having a large numerical aperture. Therefore, it is preferable that the sample-carrier complex 119 is formed in the transparent particle having both the large diameter larger than a wavelength of water and a large refractive index larger than that of water.

Returning to FIG. 5, for example, a Nd-YAG laser having a wavelength of 1064 nm and intensity of 350 mW can be used as the light source 127. The light is focused on the surface of the damming portion 111 with a lens and the like, and irradiation light intensity can be set in the range of about 50 mW to about 200 mW on the surface.

In the case where the sample-carrier complex 119 is caused to reside in the damming portion 111 by the optical tweezers 147, for example, the microchip of FIG. 5 is set on a stage of a microscope and the light from the light source 127 is focused on the downstream side of the damming portion 111 to irradiate. Then, the particle is grasped and relatively moved in parallel by moving a galvano scanner mirror. Thus, the plural sample-carrier complexes 119 are held on the downstream side of the damming portion 111 by the optical tweezers 147, which allows the sample-carrier complex 119, located on the upstream side, not to pass through the gap between the sample-carrier complexes 119 which are trapped.

In the microchip 125, the obstacle portion 113 is not provided in the damming portion 111 and the sample-carrier complex 119 is trapped by the light, so that the substrate 103 is easy to produce. Further, since the physical barrier does not exist, the clogging is not generated by the sample 121 or the carrier 123 in the obstacle portion 113. Therefore, the sample 121 extracted from the sample-carrier complex 119 by the heating can securely be moved in the second channel 106 by applying the voltage between the sample introducing portion 107 and the sample recovery portion 109.

For-example, the trigger which causes the sample-carrier complex 119 to be cleaved in the damming portion 111 can be set at the same temperature as the first embodiment. In this case, the sample-carrier complex 119 can be cleaved by heating the damming portion 111 with the heater 117.

Also, the sample-carrier complex 119 may be cleaved such that the stimulus of the light pulse stronger than that in the stemming is applied to the damming portion by changing the irradiation light from the light source 127. For example, the sample-carrier complex 119 in the damming portion 111 may be cleaved by irradiating with an IR laser beam stronger than that in the stemming. In this case, it is not necessary that the heater 117 is provided, and the light source can be used both for stemming the sample-carrier complex 119 and for extracting the sample 121, so that the apparatus configuration can be simplified.

The same sample-carrier complex 119 as the first embodiment can be used.

In the microchip 125, since the sample-carrier complex 119 is trapped by the light without providing the obstacle portion 113 in the damming portion 111, the substrate 103 is easy to produce. Further, since the physical barrier does not exist, the clogging is not generated by the sample 121 or the carrier 123 in the obstacle portion 113. Therefore, the sample 121 extracted from the sample-carrier complex 119 by the heating can securely be moved in the second channel 106 by applying the voltage between the sample introducing portion 107 and the sample recovery portion 109.

### Fifth Embodiment

This embodiment is a mode, in which the concentration dilution of the carrier 123 triggers the collapse of the sample-carrier complex 119 in the microchip 101 (FIG. 2) described in the first embodiment. The configuration of the microchip according to the embodiment is basically similar to the microchip 101. However, it is not necessary to heat the damming portion 111, so that the heater 117 is not particularly provided.

The type of the carrier 123 is appropriately selected according to the property of the sample 121. For example, a surfactant can be used as the carrier 123. The anionic or cationic ionic surfactant can be used as the surfactant. Specifically examples of the anionic surfactant include carboxylate, sulfonate, sulfate, and phosphate. For example, sodium dodecylsulfate (SDS) can be used as sulfate. For example, sodium dodecylbenzenesulfonate can be used as sulfonate. Non-ionic surfactants such as fatty ester can be used as the surfactant.

The sample-carrier complex 119 is prepared with the predetermined carrier 123 and is introduced from the sample introducing portion 107 to the first channel 105. The sample-carrier complex 119 is stemmed and condensed in the damming portion 111. Then, a liquid for diluting the carrier 123 is introduced from the sample introducing portion 107 to the first channel 105. The diluting liquid is appropriately selected according to the kinds of the carrier 123 and sample 121. For example, the buffer solution can be used. When the diluting liquid reaches the damming portion 111 of the first channel 105, the carrier 123 is diluted. In the case where the carrier 123 formed by the surfactant, the micell collapses to release the involved sample 121, when the concentration of the carrier 123 is lower than the critical micell concentration of the surfactant. Since the released sample 121 can pass through the gap between the columnar bodies 115, the sample 121 can be extracted onto the second channel 106 side.

In the embodiment, the sample-carrier complex 119 is caused to collapse by the stimulus. The stimulus is created such that the change in concentration of the carrier 123 in the damming portion 111 is generated by the dilution. Therefore, the sample-carrier complex 119 can securely be caused to collapse to extract the sample 121 on the second channel 106 by adding the diluting solution such as the buffer solution to the first channel 105 from the sample introducing portion 107, so that the sample 121 can be stably be extracted in a simple manner. Further, the stimulus is set at the dilution of the carrier 123, which allows a degree of freedom to be increased in the selection of the material for the carrier 123.

### Sixth Embodiment

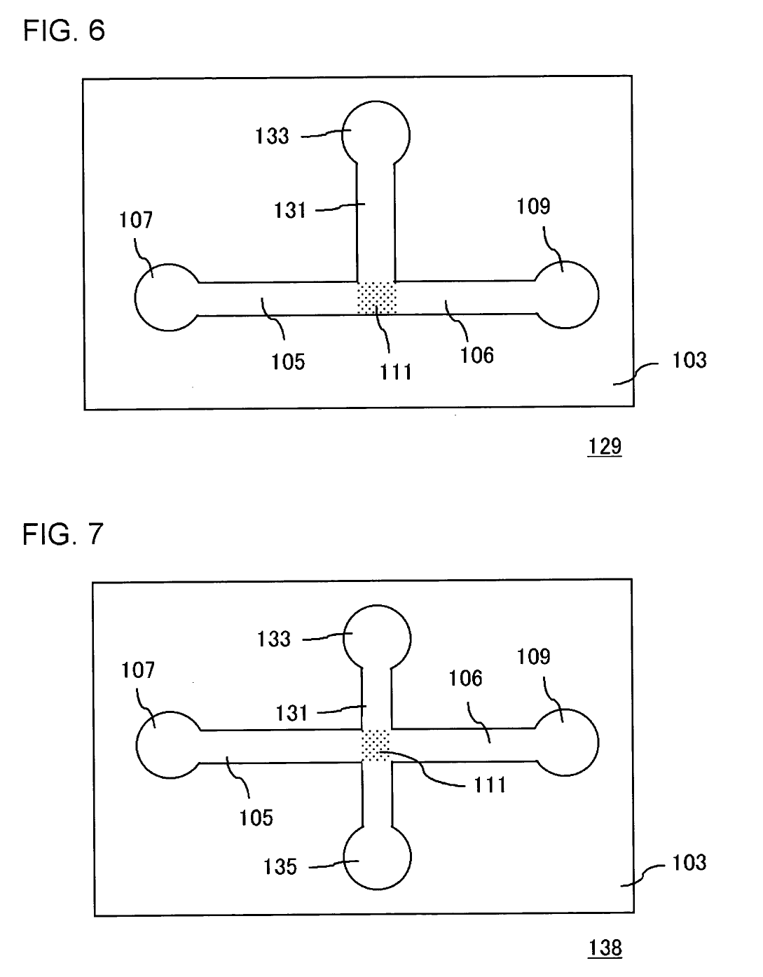

The microchips described in the first to fifth embodiments may be configured to have the plural channels. FIG. 6 is a view showing a configuration of a microchip according to this embodiment. As shown in FIG. 6, a microchip 129 includes the first channel 105, the second channel 106, and a sub-channel 131 which is communicated with the first channel 105. A reservoir 133 is provided in the sub-channel 131, and the reservoir 133 can be used for the introduction and recovery of the sample, the introduction of the reagent, and the like. The light source (not shown) is provided above the damming portion 111, and the sample can be caused to reside by the optical tweezers function like the second embodiment.

In the microchip 129, the sample is caused to reside in the damming portion 111 by the optical tweezers function. Therefore, the sample can arbitrarily be introduced from any one of liquid reservoirs of the sample introducing portion 107, the sample recovery portion 109 and the reservoir 133, and the sample can be guided to the damming portion 111 to be recovered arbitrarily from the other of liquid reservoirs.

### Seventh Embodiment

The microchips described in the first to fifth embodiments may be configured such that the plural channels intersect one another. FIG. 7 is a view showing a configuration of a microchip according to this embodiment. As shown in FIG. 7, a microchip 138 has the configuration in which the first channel 105 and the sub-channel 131 intersect each other, and the reservoir 133 and a reservoir 135 are provided in the sub-channel 131. The light source (not shown) is provided above the damming portion 111, and the sample can be caused to reside by the optical tweezers function like the second embodiment.

In the microchip 138, the sample is caused to reside in the damming portion 111 by the optical tweezers function. Therefore, the sample can arbitrarily be introduced from any one of liquid reservoirs of the sample introducing portion 107, the sample recovery portion 109, the reservoir 133 and the reservoir 135, and the sample can be guided to the damming portion 111 to be recovered arbitrarily from the other of the liquid reservoirs. In the case where the sample separation portion 149 or the sample analysis portion 151 is provided on the downstream side of the damming portion 111, the buffer solution, reagent and the like used for the separation and analysis can be introduced from these liquid reservoirs to the desired channel. Therefore, the range of the selection is extended in the separation and analysis of the sample 121, and the microchips 138 having the configurations corresponding to various purposes can be stably obtained.

Thus, the invention is described based on the embodiments. It is further understood by those skilled in the art that these embodiments are only by way of example, various modifications could be made, and the modifications are included in the scope of the invention.

For example, fatty acid may be used to form the micell in the carrier 123 used for the sample-carrier complex 119. In the case of the use of fatty acid, similarly the micell collapses to release the sample 121 by heating the damming portion 111 to a transition temperature thereof. The molecule having about C12 to about C14 can be used as fatty acid. The use of fatty acid enables the hydrophobic protein and the like to be stably carried to the damming portion 111.

Also, the micell which collapses by pH of surroundings or gel particles which swells and shrinks according to pH may be used as the carrier 123. In this case, in the microchips described in -the embodiments, the sample-carrier complex 119 is accumulated in the damming portion 111, and salt is introduced into the first channel 105 at predetermined timing. Therefore the sample-carrier complex 119 is cleaved and the sample 121 passes through the damming portion 111.

Further, the substance in which the structure change is generated by the light irradiation to release the sample 121 from the sample-carrier complex 119 may be used as the carrier 123. In this case, the light having a predetermined wavelength may be emitted from the light source 127. For example, the dendrimer having an azobenzene unit on the surface thereof can be used as the sample. A sis-trans change is generated not only by the light irradiation but by pH in the azobenzene unit, so that the sample 121 can be extracted by the above method.

### EXAMPLE

In Example, the protein was extracted by the method described in the second embodiment. First the microchip 101 having the configuration shown in FIG. 2 was prepared. However, in Example, the whole of the obstacle portion 113 was formed as the damming portion 111. The damming portion 111 was configured to have the plural rows of the columnar bodies 115. The silicon substrate was used as the substrate 103. The nano pillars were formed as the columnar bodies 115 in the substrate 103 by the method described in the first embodiment with reference to FIGS. 10 to 12. In the columnar body 115, the pattern was formed by the electron beam exposure. In the final microchip 101, the columnar bodies 115 formed in the damming portion 111 were the nano pillars having the intervals ranging from 10 nm to 50 nm.

Then, the SDS micell was caused to involve the protein. Fluorescent dyeing was performed to the protein with Cy3 which is of fluorescent dye. Therefore, the protein can be visualized by a fluorescence microscope.

The micell involving the protein was introduced to the sample introducing portion 107 of the microchip 101. Then, the micell was moved to the damming portion 111 by the electric force in the first channel 105 which was filled with the tris-boric acid buffer solution. The micell was stemmed at a region corresponding to the obstacle portion 113 by selecting the proper voltage. At this point, observation was performed with the fluorescence microscope. FIG. 19 is a top view showing a fluorescence microscope image of the first channel 105. Referring to FIG. 19, the damming portion 111 is formed in the whole of the obstacle portion 113.

From FIG. 19, the fluorescence of the protein involved in the micell was observed in the first channel 105. The fluorescence was concentrated on the obstacle portion 113, and the fluorescence was locally observed in a portion where the micell exists. On the other hand, the fluorescence was not observed in the second channel (not shown in FIG. 19). Accordingly, it is found that the micell involving the protein is stemmed by the obstacle portion 113 of the first channel 105 and the protein is condensed in the obstacle portion 113.

Then, the low-concentration buffer solution was introduced from the sample introducing portion 107 to the first channel 105 at low speed to perform the dilution of SDS which became the external stimulus. Then, the fluorescence was observed in the second channel 106. The thin-band-shaped fluorescence was observed in the second channel 106. Therefore, it is found that the concentration of SDS was lowered below the critical micell concentration to break the micell by the dilution. Further, it is found that the protein involved in the micell passed through the gap between the columnar bodies 115 and was moved to the second channel 106.

1. A microchip comprising a base material in which a channel is provided, the microchip extracting a sample from a complex of said sample and a carrier holding said sample being introduced into said channel, wherein said channel includes:
an inlet through which said complex is introduced;
a damming portion which stems said complex;
an introduction channel which is provided from said inlet to said damming portion, said complex flowing through said introduction channel; and
a sample channel which is located on a downstream side of said damming portion, said sample channel being communicated with said introduction channel through said damming portion, said sample flowing through said sample channel, said sample being extracted from said complex stemmed at said damming portion.

2. The microchip according to claim 1, comprising stimulus applying unit applying stimulus to said complex to extract said sample, said complex being stemmed at said damming portion.

3. The microchip according to claims 1, wherein said damming portion has a plurality of protrusions.

4. The microchip according to claim 3, wherein said stimulus applying unit is a heating member.

5. The microchip according to claim 3, wherein said stimulus applying unit is a light irradiation member.

6. The microchip according to claim 1, wherein said channel has a separation portion which separates a component in said sample.

7. The microchip according to claim 1, wherein said channel has an analysis portion which analyzes said sample.

8. The microchip according to claim 1, wherein said channel has a recovery portion which recovers said sample.

9. A method of extracting a sample, wherein a microchip comprising a base material in which a channel is provided is used to introduce a complex of a sample and a carrier holding said sample into said channel, and
said sample is extracted from said complex by applying stimulus to said complex.

10. A method of separating a sample, wherein, after said sample is extracted from the complex by the method of extracting a sample according to claim 9, a component in said sample extracted is separated on a downstream side of said channel.

11. The method of separating a sample according to claim 10, wherein said stimulus is applied to said complex by heating said complex.

12. The method of separating a sample according to claim 10, wherein said stimulus is applied to said complex by changing pH in said channel.

13. The method of separating a sample according to claim 10, wherein said stimulus is applied to said complex by diluting a concentration of said carrier.

14. The method of separating a sample according to claim 10, wherein said stimulus is applied after said complex is stemmed at a predetermined position in said channel.

15. The method of separating a sample according to claim 14, wherein said complex is stemmed by keeping said complex at said predetermined position by remote operation.

16. The method of separating a sample according to claim 15, wherein said remote operation is a laser trap.

17. A method of analyzing a sample, wherein after said sample is extracted from the complex by the method of extracting a sample according to claim 9, said sample extracted is analyzed on a downstream side of said channel.

18. The method of analyzing a sample according to claim 17, wherein said stimulus is applied to said complex by heating said complex.

19. The method of analyzing a sample according to claim 17, wherein said stimulus is applied to said complex by changing pH in said channel.

20. The method of analyzing a sample according to claim 17, wherein said stimulus is applied to said complex by diluting a concentration of said carrier.

21. The method of analyzing a sample as in any one of claims 17 to 20, wherein said stimulus is applied after said complex is stemmed at a predetermined position in said channel.

22. The method of analyzing a sample according to claim 21, wherein said complex is stemmed by keeping said complex at said predetermined position by remote operation.

23. The method of analyzing a sample according to claim 22, wherein said remote operation is a laser trap.

24. A method of recovering a sample, wherein after said sample is extracted from the complex by the method of extracting a sample according to claim 9, said sample extracted is recovered on a downstream side of said channel.

25. The method of recovering a sample according to claim 24, wherein said stimulus is applied to said complex by heating said complex.

26. The method of recovering a sample according to claim 24, wherein said stimulus is applied to said complex by changing pH in said channel.

27. The method of recovering a sample according to claim 24, wherein said stimulus is applied to said complex by diluting a concentration of said carrier.

28. The method of recovering a sample according to claim 24, wherein said stimulus is applied after said complex is stemmed at a predetermined position in said channel.

29. The method of recovering a sample according to claim 28, wherein said complex is stemmed by keeping said complex at said predetermined position by remote operation.

30. The method of recovering a sample according to claim 29, wherein said remote operation is a laser trap.
